(19) United States
(12) Patent Application Publication
(10) Pub. No.: US 2007/0038778 A1
(43) Pub. Date: Feb. 15, 2007

(54) Method and system for playing multimedia files

(75) Inventors: Caixia Miao, Shenzhen (CN); Qingchun Shen, Shenzhen (CN); Wenge Zhang, Shenzhen (CN); Xiaodong Chen, Shenzhen (CN); Lei Yuan, Shenzhen (CN); Wanjun Shang, Shenzhen (CN)

Correspondence Address: MERCHANT & GOULD PC, P.O. BOX 2903, MINNEAPOLIS, MN, 55402-0903, US

(73) Assignee: Huawei Technologies Co., Ltd., Shenzhen (CN)

(21) Appl. No.: 11/486,937

(22) Filed: Jul. 13, 2006

(30) Foreign Application Priority Data
Jul. 14, 2005 (CN) 200510083944.0

(51) Int. Cl. G06F 15/16

(52) U.S. Cl. 709/246

(57) ABSTRACT

The present invention discloses a method for playing audio/video files in a console at a conference in the next generation network. The method includes the following steps: the conference console sends a request for playing the audio/video files to a conference application server; the media resource server determines a media channel between the media resource server and the conference console in accordance with a request sent by the conference application server; the conference console converts a format of media streams of the audio/video files into a format supported by the media resource server, and transfers the converted media streams to the media resource server via the media channel; and the media resource server plays media stream information of the audio/video files to conference terminals. The present invention achieves playing both audio files and video files with an excellent effect, irrespective of whether the local facilities have corresponding functions of playing audio or video files.

### FIELD OF THE INVENTION

The present invention generally relates to voice conference or multimedia conference services in the next generation network, and more specifically to a method for playing local multimedia files in a communication network.

### BACKGROUND

With the development of communication techniques, the integration of telecommunications and Internet is continuously being applied, which takes the functional advantages of both computers and telephones. The appearance of various novel telecommunication services has brought many new functions into the telecommunication field. Currently, a service of voice conference or voice chat room that is initiated and controlled via WEB or intelligent terminal is widely applied, which enables a chairman of the conference or the chat room to perform control operation via WEB or intelligent terminal so as to implement various functions. At the conference, the chairman may select to play local audio/video files in the conference console for each participator. The files may include WAVE files of someone's speech recorded in real time, or music files in MP3 format, etc.

At present, the method for playing local audio/video files in a conference console is generally known to open and play the local audio/video files by use of a local player in the conference console, and the sound being magnified by the loudspeakers in the conference console is broadcast through a phone speaker to the participators at the meeting.

In this method, primarily, the loudspeakers are required for playing the audio/video files directly, which causes limitations to the conference environment and facilities. Yet, it has large noises. Moreover, only audio files can be played, whereas video images of the video files cannot be transmitted to the participators.

### SUMMARY OF THE INVENTION

The present invention provides a method for playing audio/video files stored in a conference console, which is applied to conference services in a next generation network. The method includes steps of: requesting for playing the audio/video files, wherein the conference console sends a request for playing the audio/video files to a conference application server; determining a media channel, wherein the media resource server determines the media channel between the media resource server and the conference console in accordance with a request sent by the conference application server; transferring the audio/video files, wherein the conference console converts a format of media streams of the audio/video files into a format supported by the media resource server, and transfers the converted media streams to the media resource server via the media channel; and playing the audio/video files, wherein the media resource server plays media stream information of the audio/video files to conference terminals.

The step of determining a media channel further includes: upon receiving the request sent by the conference console, the conference application server determining whether there is an existing media channel between the media resource server and the conference console, and if so, using the existing media channel; if not, establishing a new media channel between the media resource server and the conference console.

The step of establishing a new media channel between the media resource server and the conference console further includes: allocating a virtual phone number for the conference console by the conference application server upon receiving the request for playing the audio/video files from the conference console; binding the virtual phone number with an IP address and a port number of the conference console and registering the bound virtual phone number, IP address and port number to a soft switch as a soft phone terminal, by the conference console; sending a request to the conference application server for admitting the soft phone terminal to a conference by the conference console; and the conference application server requesting the media resource server to admit the conference console as the soft phone terminal to the conference after authentication and establishing the media channel between the media resource server and the conference console.

The method further includes steps of: the conference console sending an instruction for stop to notify the conference application server after the conference console interrupts playing the audio/video files or the playing is completed; and the conference application server notifying the media resource server to release the media channel and withdrawing the current virtual phone number allocated for the conference console.

In the step of requesting for playing the audio/video files, if using the existing media channel between the conference resource server and the conference console, the conference console carries media resources required for playing the audio/video files when sending the request for playing the audio/video files to the conference application server.

And in the step of determining a media channel, the conference application server determines whether the existing media channel suffices the required media resources, and if so, using the existing media channel; if not, requesting the media resource server and the conference console to modify media resources allocated for the media channel into the media resources required for playing the audio/video files.

The method further includes steps of: the conference console sending a terminating playing instruction to notify the conference application server after completing playing the files or a user stops playing the files; and recovering the media resources to an original status before modifying if the media resource server and the conference console modify the media resources allocated for the media channel.

In the above method, the existing media channel between the media resource server and the conference console is a media channel established between the soft phone terminal and the media resource server.

In the above method, if the conference console is provided with a function of audio mixing, the conference console mixes the media streams of the audio/video files and user speeches and transfers the mixed media streams to the media resource server via the media channel.

The above method further includes step of the conference application server charging for playing the audio/video files.

In another aspect, the present invention provides a method for playing multimedia files in a communication network, including: sending a playing request to a conference server by a conference management unit; upon receiving the playing request, establishing a communication channel between the conference management unit and a source server by the conference server; sending the multimedia files to the source server via the communication channel by the conference management unit; and playing the multimedia files to a plurality of user terminals locating in the communication network by the source server.

In the above method, the step of establishing a communication channel further includes: upon receiving the request sent by the conference management unit, the conference server determining whether there is an existing communication channel between the source server and the conference management unit, and if so, using the existing communication channel; if not, establishing a new communication channel between the source server and the conference management unit.

In the above method, the step of establishing a new communication channel between the source server and the conference management unit further includes: allocating a virtual phone number for the conference management unit by the conference server upon receiving the request for playing the multimedia files from the conference management unit; binding the virtual phone number with an IP address and a port number of the conference management unit and registering the bound virtual phone number, IP address and port number to a soft switch as a soft phone terminal, by the conference management unit; sending a request to the conference server for admitting the soft phone terminal to a conference by the conference management unit; and the conference server requesting the source server to admit the conference management unit as the soft phone terminal to the conference after authentication and establishing the communication channel between the source server and the conference management unit.

In the step of requesting for playing the multimedia files, if using the existing communication channel between the source server and the conference management unit, the conference management unit carries media resources required for playing the multimedia files when sending the request for playing the multimedia files to the conference server.

And in the step of determining a communication channel, the conference server determines whether the existing communication channel suffices the required media resources, and if so, using the existing communication channel; if not, requesting the media resource server and the conference management unit to modify media resources allocated for the communication channel into the media resources required for playing the multimedia files.

The above method further includes steps of: the conference management unit sending a terminating playing instruction to notify the conference server after completing playing the files or a user stops playing the files; and recovering the media resources to an original status before modifying if the media resource server and the conference management unit modify the media resources allocated for the communication channel.

In still another aspect, a system for playing multimedia files in a communication network, includes: a plurality of user terminals locating in the communication network; a conference management unit connected to the user terminals via the communication network, the conference management unit configured for sending a playing request; a conference server connected to the conference management unit via the communication network, the conference server configured for receiving the playing request; and a source server connected to the conference server, wherein the conference server establishes a communication channel between the conference management unit and source server based on the playing request; the conference management unit sends multimedia files to the source server via the communication channel while the communication channel is established; and upon receiving the multimedia files, the source server broadcasts the multimedia files to the user terminals.

In the above system, the conference server is configured for determining whether there is an existing communication channel between the source server and the conference management unit upon receiving the request sent by the conference management unit, and if so, the conference server uses the existing communication channel; if not, the conference server establishes a new communication channel between the source server and the conference management unit.

In the above system, the conference server is configured for allocating a virtual phone number for the conference management unit upon receiving the playing request from the conference management unit; the conference management unit is configured for binding the virtual phone number with an IP address and a port number of the conference management unit and registering the bound virtual phone number, IP address and port number to a soft switch as a soft phone terminal; the conference management unit is configured for sending a request to the conference server for admitting the soft phone terminal to a conference; and the conference server is configured for requesting the source server to admit the conference management unit as the soft phone terminal to the conference after authentication and establishing the communication channel between the source server and the conference management unit.

In the above system, the conference management unit is provided with a function of audio mixing, for mixing the media streams of the multimedia files and user speeches and transferring the mixed media streams to the source server via the communication channel.

According to the present invention, the user conference console as a licensed Next Generation Network (NGN) soft terminal is admitted to the conference; and through a media channel established between the media resource server and the conference console, the audio/video files stored in the conference console can be converted into those of a media stream format supported by the media resource server and then transferred to the media resource sever, where the media streams are broadcast to the conference terminals. As a result, the audio/video files can be played irrespective of whether the local facilities are provided with corresponding playing functions or not. Since the negotiation on media resource between the soft terminal and the media resource server is conducted under the session initiation protocol (SIP), and the audio/video files desired for playing are converted into media streams and transferred through NGN network, the method according to the present invention is able to play both the audio files and the video files.

Besides, since the present invention is constituted based on the NGN network architecture, it is conveniently possible for the conference application server to charge for playing the audio/video files.

### BRIEF DESCRIPTION OF THE DRAWINGS

FIG. 1 is a schematic diagram showing an architecture of a network applied in the present invention;

FIG. 2 is a flowchart showing a method according to a first embodiment of the present invention;

FIG. 3 is a flowchart showing a method according to a second embodiment of present invention.

### DETAILED DESCRIPTION OF THE INVENTION

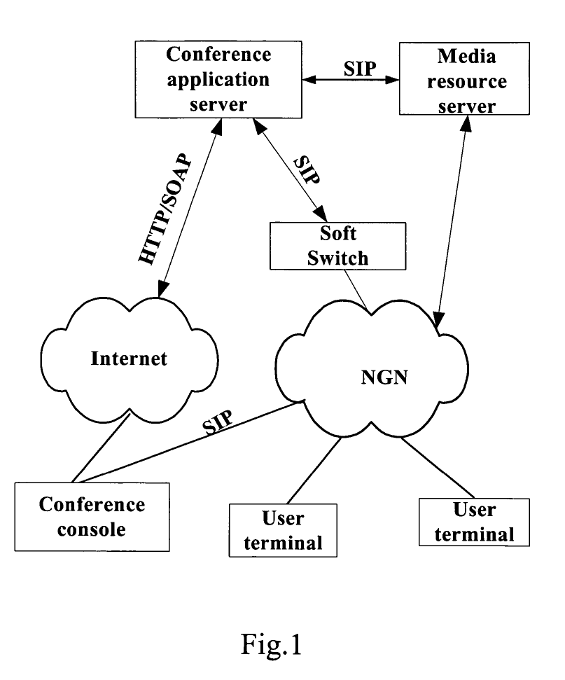

As shown in FIG. 1, the present invention provides the conference services by using a Next Generation Network (NGN) architecture, which includes network entities such as a conference console, a conference application server, a soft switch, a media resource server (MRS) and a conference terminal, etc.

In particular, the conference console provides an interface for a user to initiate and control a conference via WEB or a client. The user may utilize related functions provided by the conference services, such as inviting other user to join the conference, playing local audio/video files for participators, and terminating the conference, etc., so as to control the conference. Additionally, the conference console may communicate with the conference application server under HTTP/SOAP protocol, and may communicate with the soft switch under the standard SIP protocol.

The conference application server is a server for conference service loading and operating, which may control conference calls, and implement corresponding functions of the conference.

The soft switch performs functions such as service triggering, routing and call connection, etc. Typically, the soft switch triggers calls to the conference application server, and the conference application server takes over the subsequent control of the calls.

The media resource server (MRS) provides media resources, such as conference hall, announcement and collecting information, etc., for the conference application server.

The conference terminal, such as a phone terminal, is used by the user to attend the conference and talk with other participators.

According to the network architecture mentioned above, it is provided in the present invention a method for playing the audio/video files stored in the conference console, including the following steps.

1) The conference console sends a request for playing the audio/video files to the conference application server.

2) The conference application server sends a request to the media resource server for establishing a media channel between the conference console and the media resource server.

3) The conference console converts the format of media streams of the audio/video files stored therein into a format supported by the media resource server, and transfers them to the media resource server via the media channel.

4) The media resource server plays the media streams to the conference terminals.

Detailed descriptions of the above method will be given as below with reference to the accompanying drawings.

Hereinafter, a method according to a first embodiment of the present invention will be described.

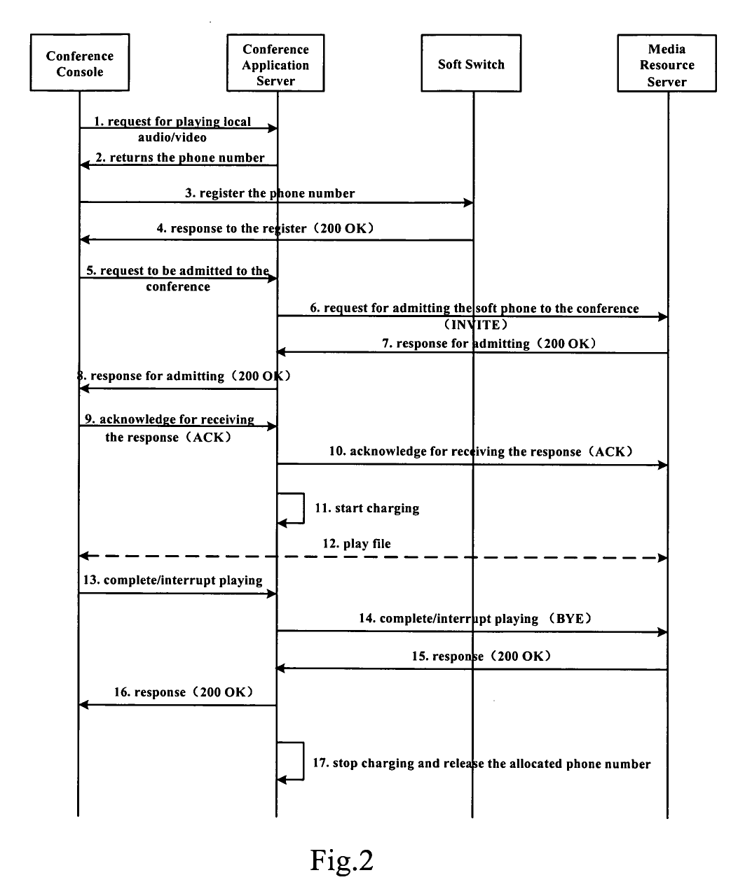

While playing the audio/video files, the conference console sends a request to the conference application server for applying a phone number and the conference application server allocates one phone number dynamically and returns that to the conference console. After that, the conference console attends the conference temporarily as a soft phone terminal, simulates a participator to speak, converts the format of media streams of the audio/video files desired to a format supported by the media server resource server, and plays the media streams. A detailed signaling flow of the present embodiment is shown in FIG. 2, which includes the following steps.

At step 1, if the chairman of the conference desires to play an audio/video file stored in the conference console to participators at a conference, he/she may send a request for playing the file to the conference application server via the conference console.

At step 2, the conference application server selects an unallocated phone number which is not open to the users (i.e. a virtual phone number) and can be dynamically maintained and allocated by the conference application server, and returns the phone number to the conference console; and further, after playing the local audio/video files, the conference application server withdraws the phone number for reuse.

At step 3, the conference console binds the phone number returned by the conference application server with an IP address and a port number of the conference console and registers the bound phone number, IP address and port number in the soft switch.

At step 4, the soft switch notifies the conference console of a result for the registering by a register response (200 OK); and if registering successfully, the conference console may participate the conference as an internal soft phone terminal of the NGN network and communicate with other phone terminals or internal soft phone terminals to receive and deliver signaling and media streams.

At step 5, after registering the soft phone terminal successfully, the conference console sends a request to the conference application server for admitting the soft phone registered by itself to the conference.

At step 6, the conference application server determines whether the soft phone number is authenticated, and if so, the conference application server requests the MRS to connect the soft phone terminal (i.e. the conference console) to the conference.

At step 7, the MRS answers the request from the conference application server and notifies the conference application server of the result that the soft phone terminal (i.e. the conference console) has been admitted to the conference.

At step 8, the conference application server notifies the conference console of the result that the soft phone terminal (i.e. the conference console) has been admitted to the conference.

At step 9, upon receiving the result, the conference console sends an acknowledge message (ACK) to the conference application server to confirm that the local audio/video file is ready for playing.

At step 10, the conference application server returns the acknowledge message (ACK) to the MRS to accomplish negotiation of the media channel.

At step 11, the conference application server starts to charge for playing the local audio/video files.

At step 12, the conference console opens the local audio/video file stored in the conference console, converts the format of media streams of the audio/video file to a format supported by the MRS, and transfers the media streams in the converted format to the MRS through the media channel established between them, whereby the MRS can perform audio mixing or playing video files to the participators.

At step 13, if the conference console interrupts playing the audio/video files or the playing is completed, the conference console sends an instruction for stop to the conference application server.

At step 14, the conference application server sends a BYE message to the MRS to notify the MRS to release media resources occupied by the media channel.

At step 15, the MRS returns a 200 OK response message to the conference application server.

At step 16, the conference application server sends a stop response message to the conference console.

At step 17, the conference application server stops charging for playing the local audio/video files, and withdraws the virtual phone number allocated for the conference console, whereby the current process of playing the local audio/video files is ended.

Hereinafter, references will be made to a method according to a second embodiment of present invention.

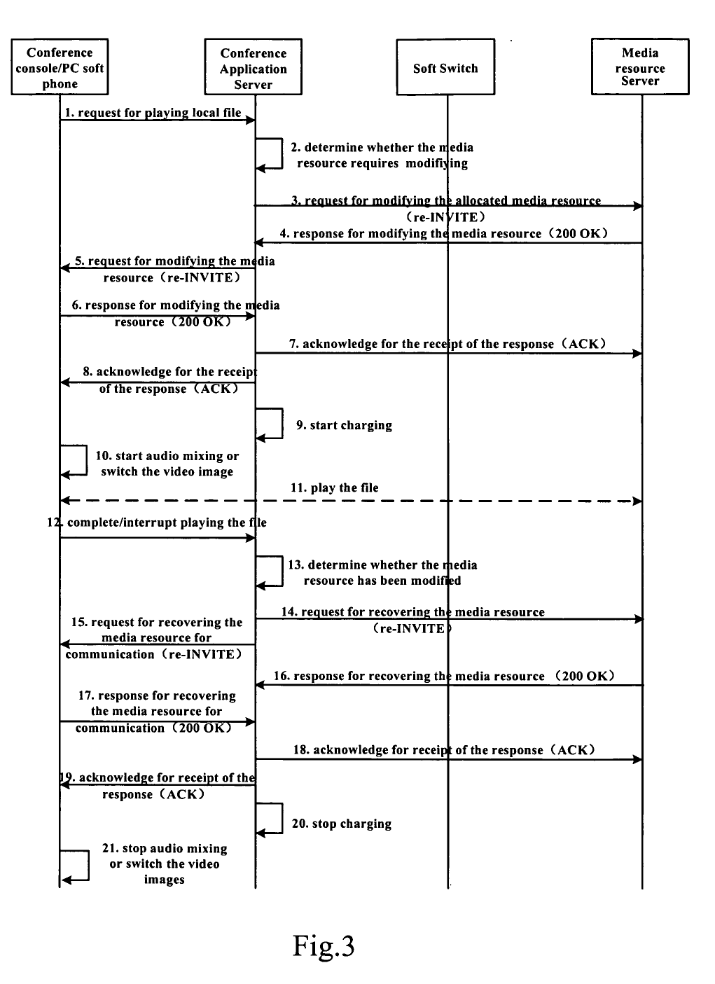

In the case that the conference console is provided with a function as a soft phone and a user has participated the conference by using the soft phone as a conference phone, it may use an existing media channel between the media resource server and the conference console to transfer the media streams while playing the local audio/video file stored in the conference console. In such a case, there is no necessity for the conference application server to allocate a phone number dynamically for registering. In this way, the existing media channel between the media resource server and the conference console is used for both playing the local files and communicating between the users. If the conference console provides a function of sound mixing, the user may communicate normally while the local files are playing. Contrarily, if the conference console provides no function of sound mixing, the user may not speak for the moment while the local files are playing. Moreover, if one requires playing a local video file, it should switch the current conference video images at the user side to images of the local video files. FIG. 3 shows a detailed signaling flow according to the present embodiment, including the following steps.

At step 1, in the case that the user is speaking by use of the soft phone terminal provided by the conference console at the conference, if the user desires to play the local audio/video files stored in the conference console, the user may select a function of playing local files by the conference console, and the conference console will send a request for playing the files to the conference application server while simultaneously carrying the media resource information required for playing the desired files.

At step 2, upon receiving the request for playing the files, the conference application server determines whether the media resource required for playing the files is identical with the current media resource occupied by the media channel used by the user for communication. If not, proceed to steps 3-8 to request the MRS and the conference console again to allocate the media resource required for playing the files; otherwise, proceed to step 9.

At step 3, the conference application server requests the MRS to modify the media resource allocated for the media channel, so as to ensure the media resource required for playing the local audio/video files.

At step 4, the MRS returns a response for modifying the media resource to the conference application server.

At step 5, the conference application server requests the soft phone terminal (i.e. the conference console) to modify its media resource into the media resource for playing the local files.

At step 6, the soft phone terminal returns a response for modifying the media resource to the conference application server.

At step 7, upon receiving the response from the MRS, the conference application server sends an acknowledge message to the MRS.

At step 8, upon receiving the response from the soft phone terminal, the conference application server sends an acknowledge message to the soft phone terminal.

At step 9, after the media resource of the soft phone terminal and the MRS are ready, the conference application server starts charging for playing the local audio/video files stored in the conference console if required.

At step 10, in order to ensure that the users communicate normally while the local files are playing, the soft phone terminal starts the function of audio mixing (if provided) to mix the audio streams of the local audio files and the speeches of the user and send the mixed audio streams to the MRS for broadcasting to the participators. In the case that a video file is desired for playing, the conference console may switch the video images at the user side to images for playing the local files, and send the video images for playing the local files to the MRS for broadcasting to all the participators.

At step 11, the conference console plays the local audio/video files through the soft phone terminal.

At step 12, if the conference console interrupts playing the audio/video files or the playing is completed, the conference console sends an instruction for stop to the conference application server.

At step 13, in order for the conference application server to recover the media resource used by the user in normal communication, the conference application server determines whether the media resource has been modified while playing the local audio/video files, and if so, proceed to steps 14-19 to recover the media resource for normal communication of the user; if not, proceed to step 20.

At step 14, the conference application server requests the MRS to recover the media resource allocated for the soft phone terminal.

At step 15, the conference application server requests the soft phone terminal to recover the media resource for normal communication.

At step 16, the MRS returns an answer message for recovering the media resource for normal communication to the conference application server.

At step 17, the soft phone terminal returns a response message for recovering the media resource for normal communication to the conference application server.

At step 18, upon receiving the answer message from the MRS, the conference application server sends an acknowledge message to the MRS.

At step 19, upon receiving the response message from the soft phone terminal, the conference application server sends an acknowledge message to the soft phone terminal.

At step 20, the conference application server stops charging for playing the local audio/video files.

At step 21, the conference console stops the function of audio mixing and switches the video images for playing local files to the conference video images for the user.

In the second embodiment, it is possible to use the existing media channel between the media resource server and the soft phone terminal (i.e. conference console) to transfer the media streams while playing the local audio/video files, since the conference console is provided with a function of soft phone and it has participated the conference as a soft phone terminal. Certainly, when the media resource occupied by the existing media channel cannot satisfy for playing the local audio/video files, it requires modifying the media resource allocated for the same media channel to meet the requirement for playing the local audio/video files.

It will be apparent to those skilled in the art that various modifications and variations can be made in the present invention without departing the spirit and the scope of the invention. Thus, it is intended that the present invention covers the modifications and variations of this invention provided they come within the scope of the appended claims and their equivalents.

1. A method for playing audio/video files stored in a conference console, which is applied to conference services in a next generation network, comprising steps of:
requesting for playing the audio/video files, wherein the conference console sends a request for playing the audio/video files to a conference application server;
determining a media channel, wherein the media resource server determines the media channel between the media resource server and the conference console in accordance with a request sent by the conference application server;
transferring the audio/video files, wherein the conference console converts a format of media streams of the audio/video files into a format supported by the media resource server, and transfers the converted media streams to the media resource server via the media channel; and
playing the audio/video files, wherein the media resource server plays media stream information of the audio/video files to conference terminals.

2. The method according to claim 1, wherein the step of determining a media channel further comprises:
upon receiving the request sent by the conference console, the conference application server determining whether there is an existing media channel between the media resource server and the conference console, and if so, using the existing media channel; if not, establishing a new media channel between the media resource server and the conference console.

3. The method according to claim 2, wherein the step of establishing a new media channel between the media resource server and the conference console further comprises:
allocating a virtual phone number for the conference console by the conference application server upon receiving the request for playing the audio/video files from the conference console;
binding the virtual phone number with an IP address and a port number of the conference console and registering the bound virtual phone number, IP address and port number to a soft switch as a soft phone terminal, by the conference console;
sending a request to the conference application server for admitting the soft phone terminal to a conference by the conference console; and
the conference application server requesting the media resource server to admit the conference console as the soft phone terminal to the conference after authentication and establishing the media channel between the media resource server and the conference console.

4. The method according to claim 3, further comprising steps of:
the conference console sending an instruction for stop to notify the conference application server after the conference console interrupts playing the audio/video files or the playing is completed; and
the conference application server notifying the media resource server to release the media channel and withdrawing the current virtual phone number allocated for the conference console.

5. The method according to claim 2, wherein
in the step of requesting for playing the audio/video files, if using the existing media channel between the conference resource server and the conference console, the conference console carries media resources required for playing the audio/video files when sending the request for playing the audio/video files to the conference application server, and
in the step of determining a media channel, the conference application server determines whether the existing media channel suffices the required media resources, and if so, using the existing media channel; if not, requesting the media resource server and the conference console to modify media resources allocated for the media channel into the media resources required for playing the audio/video files.

6. The method according to claim 5, further comprising steps of:
the conference console sending a terminating playing instruction to notify the conference application server after completing playing the files or a user stops playing the files; and
recovering the media resources to an original status before modifying if the media resource server and the conference console modify the media resources allocated for the media channel.

7. The method according to claim 5, wherein the existing media channel between the media resource server and the conference console is a media channel established between the soft phone terminal and the media resource server.

8. The method according to claim 7, wherein if the conference console is provided with a function of audio mixing, the conference console mixes the media streams of the audio/video files and user speeches and transfers the mixed media streams to the media resource server via the media channel.

9. The method according to claim 1, further comprising the conference application server charging for playing the audio/video files.

10. A method for playing multimedia files in a communication network, comprising:
sending a playing request to a conference server by a conference management unit;
upon receiving the playing request, establishing a communication channel between the conference management unit and a source server by the conference server;
sending the multimedia files to the source server via the communication channel by the conference management unit; and
playing the multimedia files to a plurality of user terminals locating in the communication network by the source server.

11. The method according to claim 10, wherein establishing a communication channel further comprises:
upon receiving the request sent by the conference management unit, the conference server determining whether there is an existing communication channel between the source server and the conference management unit, and if so, using the existing communication channel; if not, establishing a new communication channel between the source server and the conference management unit.

12. The method according to claim 11, wherein establishing a new communication channel between the source server and the conference management unit further comprises:
allocating a virtual phone number for the conference management unit by the conference server upon receiving the request for playing the multimedia files from the conference management unit;
binding the virtual phone number with an IP address and a port number of the conference management unit and registering the bound virtual phone number, IP address and port number to a soft switch as a soft phone terminal, by the conference management unit;
sending a request to the conference server for admitting the soft phone terminal to a conference by the conference management unit; and
the conference server requesting the source server to admit the conference management unit as the soft phone terminal to the conference after authentication and establishing the communication channel between the source server and the conference management unit.

13. The method according to claim 11, wherein
in the step of requesting for playing the multimedia files, if using the existing communication channel between the source server and the conference management unit, the conference management unit carries media resources required for playing the multimedia files when sending the request for playing the multimedia files to the conference server, and
in the step of determining a communication channel, the conference server determines whether the existing communication channel suffices the required media resources, and if so, using the existing communication channel; if not, requesting the media resource server and the conference management unit to modify media resources allocated for the communication channel into the media resources required for playing the multimedia files.

14. The method according to claim 13, further comprising steps of:
the conference management unit sending a terminating playing instruction to notify the conference server after completing playing the files or a user stops playing the files; and
recovering the media resources to an original status before modifying if the media resource server and the conference management unit modify the media resources allocated for the communication channel.

15. A system for playing multimedia files in a communication network, comprising:
a plurality of user terminals locating in the communication network;
a conference management unit connected to the user terminals via the communication network, the conference management unit configured for sending a playing request;
a conference server connected to the conference management unit via the communication network, the conference server configured for receiving the playing request; and
a source server connected to the conference server,
wherein the conference server establishes a communication channel between the conference management unit and source server based on the playing request;
the conference management unit sends multimedia files to the source server via the communication channel while the communication channel is established; and
upon receiving the multimedia files, the source server broadcasts the multimedia files to the user terminals.

16. The system according to claim 15, wherein
the conference server is configured for determining whether there is an existing communication channel between the source server and the conference management unit upon receiving the request sent by the conference management unit, and if so, the conference server uses the existing communication channel; if not, the conference server establishes a new communication channel between the source server and the conference management unit.

17. The system according to claim 16, wherein
the conference server is configured for allocating a virtual phone number for the conference management unit upon receiving the playing request from the conference management unit;
the conference management unit is configured for binding the virtual phone number with an IP address and a port number of the conference management unit and registering the bound virtual phone number, IP address and port number to a soft switch as a soft phone terminal;
the conference management unit is configured for sending a request to the conference server for admitting the soft phone terminal to a conference; and
the conference server is configured for requesting the source server to admit the conference management unit as the soft phone terminal to the conference after authentication and establishing the communication channel between the source server and the conference management unit.

18. The system according to claim 15, wherein the conference management unit is provided with a function of audio mixing, for mixing the media streams of the multimedia files and user speeches and transferring the mixed media streams to the source server via the communication channel.
